(19) United States
(12) Patent Application Publication
(10) Pub. No.: US 2018/0240052 A1
(43) Pub. Date: Aug. 23, 2018

(54) RECOMMENDATION SERVICE FOR AD-HOC BUSINESS INTELLIGENCE REPORT ANALYSIS

(71) Applicant: International Business Machines Corporation, Armonk, NY (US)

(72) Inventors: Munish GOYAL, Yorktown Heights, NY (US); Wing L. LEUNG, Austin, TX (US); Sarbajit K. RAKSHIT, Kolkata (IN); Kimberly Greene STARKS, Nashville, TN (US)

(21) Appl. No.: 15/437,777

(22) Filed: Feb. 21, 2017

(51) Int. Cl. G06Q 10/06

(52) U.S. Cl. CPC G06Q 10/0637

(57) ABSTRACT

A method, computer program product, and system includes a processor(s) identifying, in at least one data dictionary associated with a reporting tool, report objects available in the generation of an ad-hoc report with the reporting tool. The processor(s) contextualizes, at a given time, data accessible to the processor(s), based on utilizing one or more communications connections. The processor(s) determines, based on the at least one data dictionary associated with a reporting tool and the contextualized data, which report objects of the report objects available in the generation of an ad-hoc report are relevant to generating the ad-hoc report proximate to the given time. The processor(s) provides the relevant report objects to the reporting tool.

### BACKGROUND

When a business user performs ad-hoc analyses using business intelligence reporting tools, the tool offers the user the option of selecting various filters, dimension, measures, and/or key performance indicators (KPIs). The options in the tool are offered to meet with needs of business intelligence (BI) data analyses. After selecting options and creating a report with the tool, some tools offer “drill-down” options, allowing the user to explore certain portions of the report on a more granular level. Utilizing the dynamic analysis options available in the tools is user-driven and can be work-intensive for a user, who will specify options and manually drill-down to locate relevant data.

### SUMMARY

Shortcomings of the prior art are overcome and additional advantages are provided through the provision of a method for streamlining an ad-hoc report in a reporting tool. The method includes, for instance: identifying, by the one or more processors, in at least one data dictionary associated with a reporting tool, report objects available in the generation of an ad-hoc report with the reporting tool; contextualizing, by the one or more processors, at a given time, data accessible to the one or more processors, based on utilizing one or more communications connections; determining, by the one or more processors, based on the at least one data dictionary associated with a reporting tool and the contextualized data, which report objects of the report objects available in the generation of an ad-hoc report are relevant to generating the ad-hoc report proximate to the given time; and providing, by the one or more processors, the relevant report objects to the reporting tool.

Shortcomings of the prior art are overcome and additional advantages are provided through the provision of a computer program product for streamlining an ad-hoc report in a reporting tool. The computer program product comprises a storage medium readable by a processing circuit and storing instructions for execution by the processing circuit for performing a method. The method includes, for instance: identifying, by the one or more processors, in at least one data dictionary associated with a reporting tool, report objects available in the generation of an ad-hoc report with the reporting tool; contextualizing, by the one or more processors, at a given time, data accessible to the one or more processors, based on utilizing one or more communications connections; determining, by the one or more processors, based on the at least one data dictionary associated with a reporting tool and the contextualized data, which report objects of the report objects available in the generation of an ad-hoc report are relevant to generating the ad-hoc report proximate to the given time; and providing, by the one or more processors, the relevant report objects to the reporting tool.

Methods and systems relating to one or more aspects are also described and claimed herein. Further, services relating to one or more aspects are also described and may be claimed herein.

Additional features are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is an illustration of certain aspects of an embodiment of the present invention;

FIG. 2 is a workflow illustrating certain aspects of an embodiment of the present invention;

FIG. 3 is a workflow illustrating certain aspects of an embodiment of the present invention;

FIG. 4 is an illustration of certain aspects of an embodiment of the present invention;

FIG. 5 is an illustration of certain aspects of an embodiment of the present invention;

FIG. 6 depicts one embodiment of a computing node that can be utilized in a cloud computing environment;

FIG. 7 depicts a cloud computing environment according to an embodiment of the present invention; and

FIG. 8 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

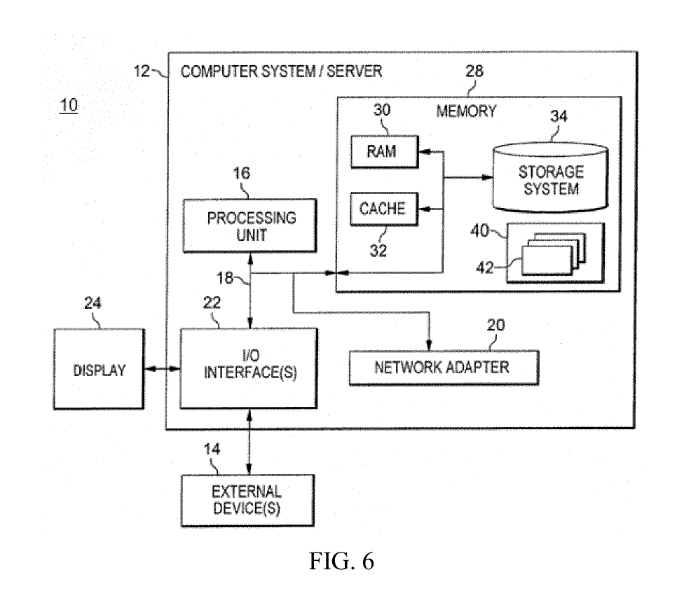

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 6 as program/utility 40, having a set (at least one) of program modules 42, may be stored in memory 28.

Embodiments of the present invention include computer system, a computer-implemented method, and a computer program product that include one or more programs that provide a reporting (business intelligence) application with automatic dynamic recommendations of one or more objects that the reporting application can utilize in an ad-hoc analysis of a business intelligence (BI) report. In some embodiments of the present invention, one or more programs collect data from various data sources and performs a contextual analysis of the gathered data to identify relevant dimensions, attributes, measures, KPIs, filter criteria, and/or drilling directions. Based on this analysis, the one or more programs pass certain resultant dimensions, attributes, measures, KPIs, filter criteria, and/or drilling directions, etc. to a reporting application for use in an ad-hoc analysis of a report (e.g., a BI report). In some embodiments of the present invention, the one or more programs provide this analysis, in addition to determining the factors that are utilized in the analysis. In some embodiments of the present invention, the one or more programs determine the recommendations based, at least in part, on determining a user's role and privileges, as configured within the technical environment in which the reporting tool has been implemented.

Certain aspects of embodiments of the present invention provide advantages inextricably tied to computing by utilizing machine learning and data mining and analysis, in order to enhance the functionality of a computer-based reporting tool. In general, when interacting with reporting applications, users are empowered to analyze the organizational data, stored in one or more databases, based on the dynamic needs of the user. The purpose of ad-hoc reporting is to empower the user to perform various analyses, as per user's dynamic needs. The needs of a specific user may vary temporally and can also depend on various factors, including but not limited to, external influences and internal influence, etc. Thus, reporting tools can become difficult to use and performance will suffer, if the reporting tools offer ad-hoc functionality related to all of the factors (e.g., dimensions, attributes, measures, KPIs, filter criteria, and/or drilling directions, etc.) that a user may wish to apply to a given report. Thus, in embodiments of the present invention, one or more programs provide recommendations which can assist users in performing ad-hoc analyses. The one or more programs can be understood as a “recommendation service” that guides an ad-hoc reporting process.

Embodiments of the present invention include software installed on a reporting server (a server that executes a reporting tool) and/or accessible for execution by one or more processors that execute a reporting tool, that recommend reporting attributes to a user during ad-hoc report generation. These attributes include, but are not limited to, a user's role-specific limitations, dimensions, KPIs, filter criteria, and/or drilling directions. In embodiments of the present invention, the one or more programs provide these recommendations based on factors including, but not limited to: the contextual importance of any dimension, attribute and/or KPI, because of external influence(s). The one or more programs determine this contextual importance by performing a big data analysis, which includes identifying (mining) and analyzing relevant data in social media, blogs, and/or other reputed sources. Based on identifying and analyzing these data, the one or more programs coordinate the data to relevant attributes, also referred to as report objects, (e.g., dimensions, measures, KPIs, attribute values, etc.) available within an ad-hoc reporting tool and recommend usage of these relevant attributes to a user, when the user is performing an ad-hoc analysis.

Aspects of certain embodiments of the present invention utilize context analysis to improve existing ad-hoc reporting tools, rendering the tools themselves more efficient and improving the user experience as well. Thus, embodiments of the present invention offer various advantages over existing reporting tools.

One advantage of embodiments of the present invention is that one or more programs tailor report objects (and recommendations of report objects) based on the usage patterns of various (business) users. For a given reporting platform, one or more programs in an embodiment of the present invention monitor and analyze user-driven factors, including but not limited to, the average number of users, the frequency of usage, the profiles of the users, the usage patterns of users as related to various KPIs, dimensions, attributes, filters etc., in view of other contextual factors, and/or the changes over time in these usage patterns. For example, for an identified context, most business users are using an Attribute 1 and an Attribute 2 are in a filter, as well as applying KPI 1, and performing drilling in Dimension 3. Based on this user behavior, the one or more programs self-learn about the usage pattern of these various report objects (KPI, dimension-attribute, filters etc.) and will identify for what scenario what report objects should be used during ad-hoc analysis, and accordingly recommend these report objects to the user during ad-hoc analysis.

Another advantage of embodiments of the present invention over existing reporting tools is that when utilizing aspects of these embodiments with a reporting tool, one or more programs identify internal and/or external influential context, and/or usage patterns, and based on this context and usage the one or more programs will identify and recommend report objects (e.g., KPIs, dimension-attributes, attributes, filters, drilling directions, etc.), and notify the user of the recommendation, such that the user can perform ad-hoc analyses (with the reporting tool), based on these objects. In another embodiments of the present invention, one or more programs will generate a basic ad-hoc report template in the reporting tool, which includes the recommended objects, to improve productivity.

Another advantage offered by embodiments of the present invention over utilizing existing reporting tools, is that one or more programs in embodiments of the present invention dynamically clean up the ad-hoc queries the user creates by interacting with the reporting tool. This cleanup improves execution efficiency by applying report objects with relevant weighting of these objects (i.e., based on assigning priority scores).

Rather than rely, in a large part, on human defined rules/algorithms for the identification and use of specific variables/attributes/dimensions for the generation of BI reports, like existing reporting tools, embodiments of the present invention leverage cognitive discovery and processing of external and internal events as the trigger mechanism for creating business intelligence reports. For example, if a sudden rise in a raw material price could affect the business user, traditional systems would not take this factor into account when generating a report, unless an administrator had previously anticipated this attribute and built it into the report. In embodiments of the present invention, rather than rely on this user foresight, one or more programs in an embodiment of the present invention will generate this business intelligence report object automatically, based on determining that this factor is relevant. Thus, in embodiments of the present invention, one or more programs automatically discover and leverage external and internal events/influences for creation of business intelligence (and other) reports.

Embodiments of the present invention can be understood as automated customizations to reporting tools, with specific utility in business intelligence reporting. To this end, embodiments of the present invention provide at least three usability advantages over existing business intelligence reporting systems. First, embodiments of the present invention do not require an initial selection of a set of dimension and measure objects because the program code generates the reports via influence discovery. Second, embodiments of the present invention apply cognitive algorithms to identify and discover relationships between objects (and therefore the attributes and measures), rather than, like existing systems, relying solely on analytical models (e.g., embodiments of the present invention do not require analytics to discover that a bicycle's cost is related to the cost of a bicycle wheel, because that is extracted via a machine learning process). Third, embodiments of the present invention utilize contextual analysis not only to provide an initial list of report objects (e.g., dimension and measure objects), but also allow to discover new report objects for reporting (e.g., program code in an embodiment of the present invention will identify an external influence that affects a dimension and include that in the relevant report objects).

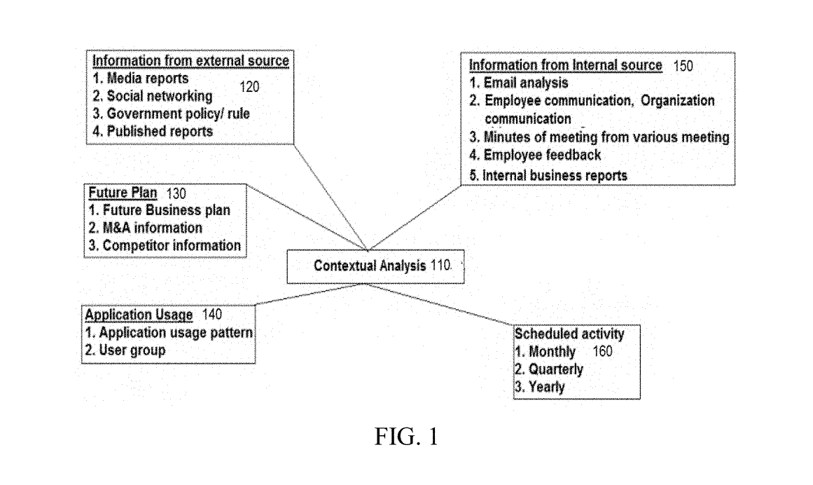

FIG. 1 is a visual representation of the contextual analysis performed by one or more programs in an embodiment of the present invention. As aforementioned, as part of the contextual analysis 110, one or more programs in an embodiment of the present invention identify relevant report objects (e.g., KPIs, dimensions, attributes, filters, drilldown paths, etc.) for use during as ad-hoc analysis performed by one or more programs in a reporting tool. The one or more programs recommend the identified objects to a user engaged in an ad-hoc reporting session. As illustrated in FIG. 1, to perform this contextual analysis, the one or more programs in an embodiment of the present invention can utilize various communication connections to access various data sources that will inform the object identification. In this example, during the contextual analysis, the one or more programs access information from external sources 120 (e.g., media reports, social networking, government policy/rule(s), and/or published reports), future plan information 130 (e.g., future business plans, merger and acquisition information, and/or competitor information), application usage 140 (e.g., application usage patterns, and/or user groups), information from internal source(s) 150 (e.g., email analyses, employee and organizational communications, minutes from meetings, employee feedback, and/or internal business reports), and scheduled activity 160 (e.g., monthly, quarterly, and/or yearly activities). FIG. 1 is just one example of certain data that may be available to various embodiments of the present invention for utilization in providing a recommendation service to a reporting tool.

Certain hypothetical situations illustrate the utility of the contextual analysis 110 performed by one or more programs in an embodiment of the present invention illustrated in FIG. 1. For example, in one scenario, a user is utilizing a reporting tool to generate an ad-hoc report at a time that is contemporaneous with the governments announcing environmental standards. Thus, dimensions and KPIs related to the environment will become important, so one or more programs in an embodiment of the present invention notify the user that report tools should be utilized based on this information. In another example, if a government announces new tax rules, KPI and dimensions related to finance will gain importance, so one or more programs in an embodiment of the present invention can recommend to a user to perform analyses that model financial impacts of these changes. In another example, a company may make an announcement related to policies and guidelines. In this scenario, the one or more programs in an embodiment of the present invention would recommend to the ad-hoc reporting software (and therefore the user as well), report objects related to dimensions and measures that are relevant to internal targets. Finally, based on an upcoming management meeting, the one or more programs in an embodiment of the present invention may recommend report objects that relate to past meetings and to the attendees of the upcoming meeting.

In embodiments of the present invention, the priority of various report objects, and therefore the recommendation of these objects by the one or more programs, changes over time, based on internal, external, and user-specific factors. For example, in a business environment, the importance of various KPIs can depend on scheduled closing activities (e.g., periodic closing targets of various organizational KPIs, the financial calendar, the calendar year, periodic, e.g., quarterly and/or yearly, closing activities, sales quantity, profitability etc.). Thus, depending upon these activities, the one or more programs will assess and assign different priorities to report objects (dimensions, filter criteria, and/or measures etc.). The priority levels assigned to the report objects are referred to herein as priority scores. In addition to these external and internal factors affecting the priority of a report object, and, ultimately, whether the one or more programs in an embodiment of the present invention recommends the object, the activity of a user utilizing an ad-hoc reporting tool can also influence the priority score that the one or more programs assign a report object. For example, in embodiments of the present invention, one or more programs in an embodiment of the present invention monitor the usage of the user of an ad-hoc reporting tool and learn (e.g., based on machine learning algorithms) the user's usage pattern, and make recommendations based on the past usage of the user. Additionally, in embodiments of the present invention, the one or more programs may make recommendations to a new user based on the usage of a different user, under a similar context. For example, the one or more programs may de-prioritize rarely used report objects for a new user, based on past usage by a (similarly situated) different user.

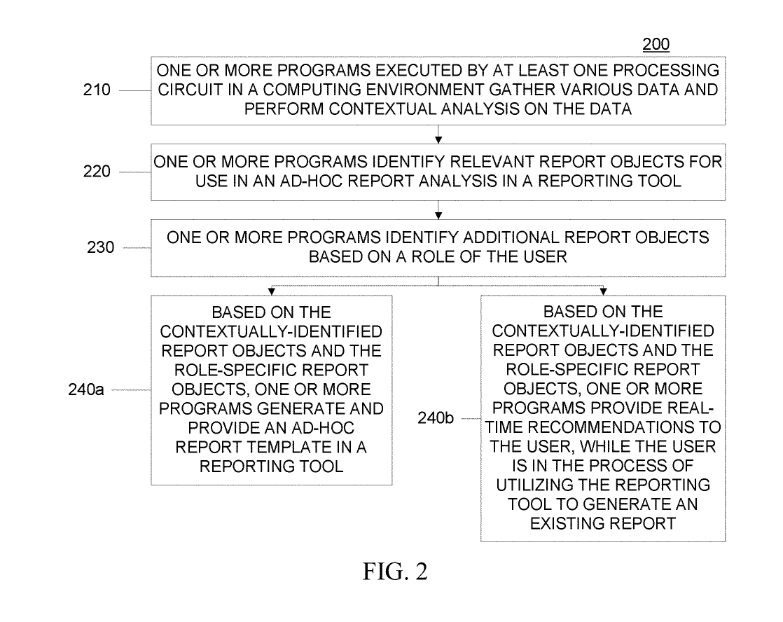

FIG. 2 is a workflow 200 that illustrates certain aspects of embodiments of the present invention. Specifically, the workflow 200 illustrates how one or more programs in an embodiment of the present invention analyze context surrounding usage of a reporting tool, and provide recommendations and/or other automatic functionality, upon identifying relevant report objects for use in generating ad-hoc reports in the reporting tool. As illustrated in FIG. 2, one or more programs in an embodiment of the present invention gather various data and perform a contextual analysis of the data (210). Based on the contextual analysis, the one or more programs identify relevant report objects for use in an ad-hoc report analysis in a reporting tool (220). In embodiments of the present invention, the one or more programs identify relevant report objects based on contextual analysis of various content, including data dictionaries. Upon identifying the report objects, the one or more programs identify additional report objects based on a role of the user (e.g., during ad-hoc analysis) (230). Based on the contextually-identified report objects and the role-specific report objects, the one or more programs generate and provide an ad-hoc report template in a reporting tool (240a) or provide real-time recommendations to the user, while the user is in the process of utilizing the reporting tool to generate an existing report (240b).

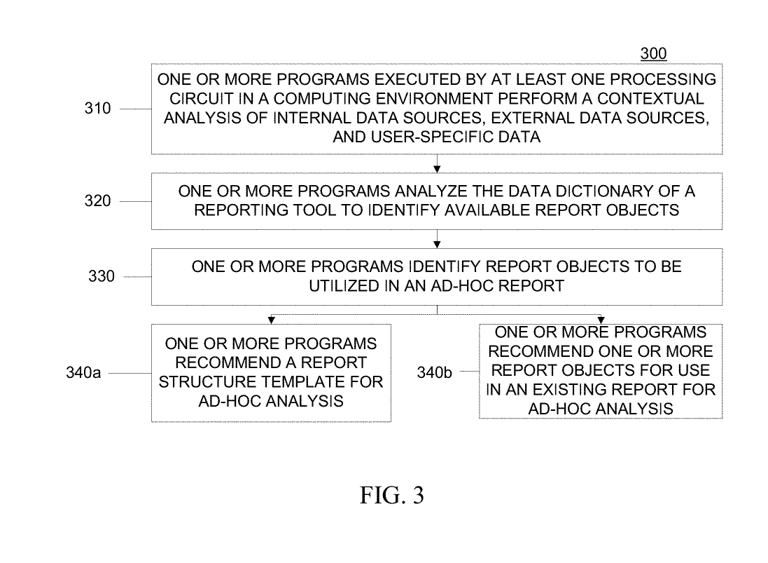

FIG. 3 is another workflow 300 that illustrates certain aspects of embodiments of the present invention. In an embodiment of the present invention, one or more programs perform a contextual analysis of internal data sources, external data sources, and user-specific data (310). For example, in embodiments of the present invention, the one or more programs gather data from one or more of: external sources, internal sources, report data, and/or usage logs. FIG. 1 provides examples of the data sources that can be utilized by the one or more programs to gather data and to subsequently contextualize a report.

Returning to FIG. 3, the one or more programs analyze the data dictionary of a reporting tool to identify available report objects (e.g., dimensions, attributes, KPIs, filters, data and metadata from the data dictionary) (320). In an embodiment of the present invention, each report object includes additional information, including but not limited to, description and purpose, which is stored in the aforementioned data dictionary. The one or more programs utilize this data dictionary, and the information available based on accessing the data dictionary, to identify context relevant report objects.

The one or more programs may perform the contextual analysis and the data dictionary analysis in parallel. In an embodiment of the present invention, the one or more programs gather various information from different sources (e.g., external sources, internal sources, future plans, and/or application usage patterns) and in performing a contextual analysis of the content, the one or more programs compare the same against the report object data dictionary.

In an embodiment of the present invention, the one or more programs identify report objects (e.g., dimensions, attributes, KPIs, filters, etc.) to be utilized in an ad-hoc report (330). Thus, the one or more programs perform a contextual analysis of the gathered data to identify which report objects are relevant to a current ad-hoc analysis. In an embodiment of the present invention, as part of identifying the report objects, the one or more programs also rank the report objects based on priority score, for the identified context.

In an embodiment of the present invention, once the one or more programs identify relevant report objects based on historical usage patterns of the user and/or of other users in similar contextual situations. The one or more programs may update the identified report objects based on these patterns. For example, the one or more programs may utilize usage patterns to revise the priorities of certain report objects.

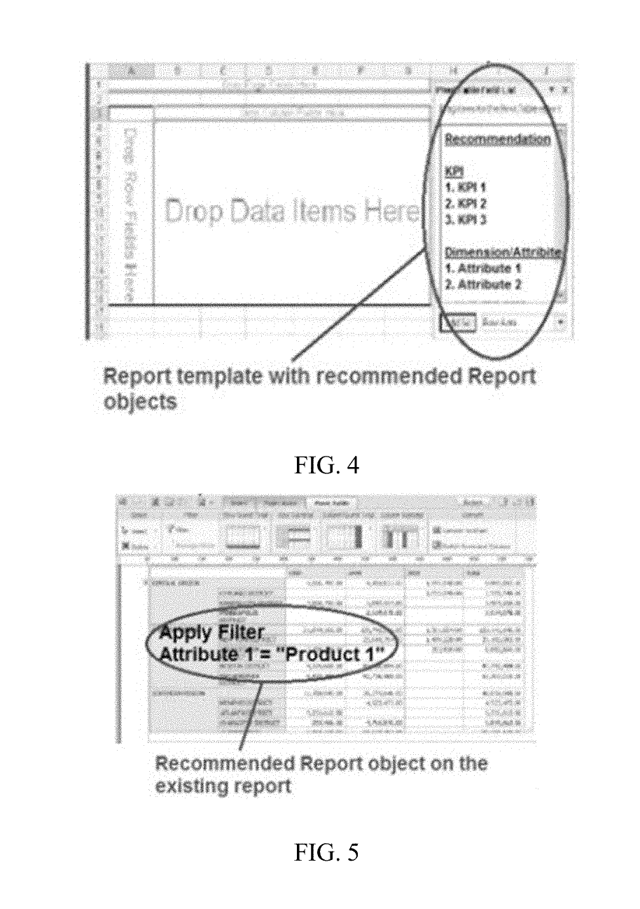

Based on identifying report objects, the one or more programs may either recommend a report structure template for ad-hoc analysis (340a) and/or recommend one or more report objects for use in an existing report for ad-hoc analysis. FIG. 4 is an example of a template with recommended report objects (e.g., FIG. 3, 340a), while FIG. 5 is an example of the one or more programs populating a recommended report object in an existing report (e.g., FIG. 3, 340b). As seen in FIG. 5, the one or more programs overlay a report object over an existing report. The user can select this recommendation through a graphical user interface (GUI) to modify the report.

Embodiments of the present invention include a computer-implemented method, a computer program product, and a computer system that streamline utilization of an ad-hoc report in a reporting tool. In an embodiment of the present invention, one or more programs identify, in at least one data dictionary associated with a reporting tool, report objects available in the generation of an ad-hoc report with the reporting tool. The one or more programs contextualize, at a given time, data accessible to the one or more processors, based on utilizing one or more communications connections. The one or more programs determine, based on the at least one data dictionary associated with a reporting tool and the contextualized data, which report objects of the report objects available in the generation of an ad-hoc report are relevant to generating the ad-hoc report proximate to the given time. The one or more programs provide the relevant report objects to the reporting tool.

How the one or more programs provide the relevant report objects can vary depending upon the embodiment. In certain embodiments of the present invention, the one or more programs provide the report objects by configuring a reporting template in the reporting tool, where the reporting template includes the relevant report objects, and utilizing, the reporting template to generate the ad-hoc report in the reporting tool. In other embodiments of the present invention, the one or more programs provide the report objects by providing, through a graphical user interface of the reporting tool, concurrent with manual selection of a user of report objects in the reporting tool to generate the ad-hoc report, a recommendation, to the user, to select at least on report object of the relevant report objects in generating the ad-hoc report.

In some embodiments of the present invention the data accessible to the one or more processors includes logs detailing interactions of at least one user with the reporting tool to generate the ad-hoc report and the one or more programs also monitor user interaction with the reporting tool to generate the ad-hoc report.

In some embodiments of the present invention, the one or more programs determine a role of a user interacting with the reporting tool to generate the ad-hoc report. The one or more programs select at least one additional report object from the available report objects, based on the role of the user, and aggregate the at least one additional report object with the recommended report objects.

In some embodiments of the present invention, the relevant report objects are each selected from the group consisting of: a filter, a dimension, a measure, a key performance indicator, an attribute, and a drilling direction.

In some embodiments of the present invention, the data accessible to the one or more processors comprises data from sources internal to a computer system executing the reporting tool. In some embodiments, the data sources are selected from the group consisting of: emails, employee communications, organizational communications, minutes from meetings, employee feedback, and internal business reports. In some embodiments, the data accessible to the one or more processors comprises data from sources external to a computer system executing the reporting tool. And in some embodiments, the data sources are selected from the group consisting of: media reports, social networking platforms, government policies, and published reports.

In an embodiment of the present invention, the one or more programs determine a role of a user interacting with the reporting tool to generate the ad-hoc report. The one or more programs identify at least one additional user in the role, wherein the at least one additional user generated the ad-hoc report proximate to the given time. The one or more programs determine specific report objects utilized by the at least one additional user. The one or more programs aggregate the specific report objects utilized by the at least one additional user with the recommended report objects.

Referring now to FIG. 6, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the a computing device housing a reporting server and/or executing programs that perform the contextual analysis can be understood as cloud computing node 10 (FIG. 6) and if not a cloud computing node 10, then one or more general computing node that includes aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

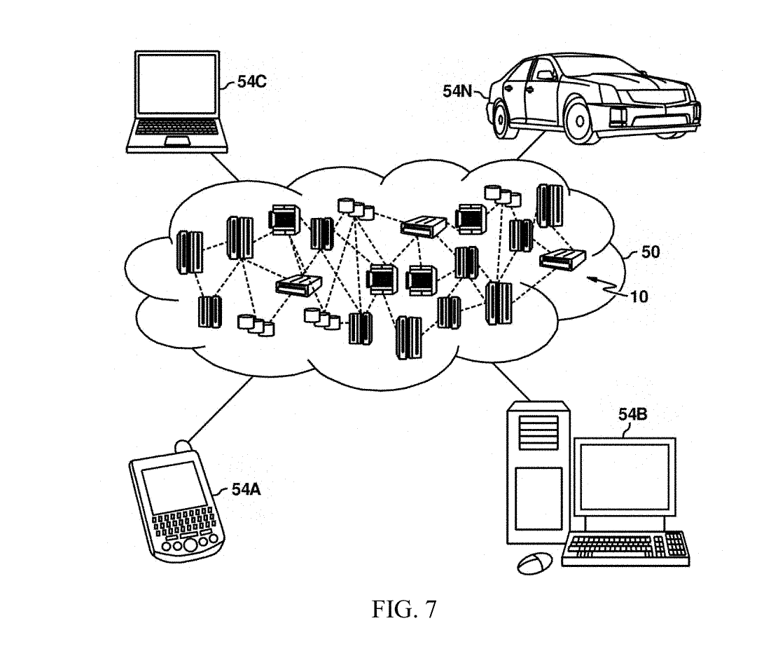

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

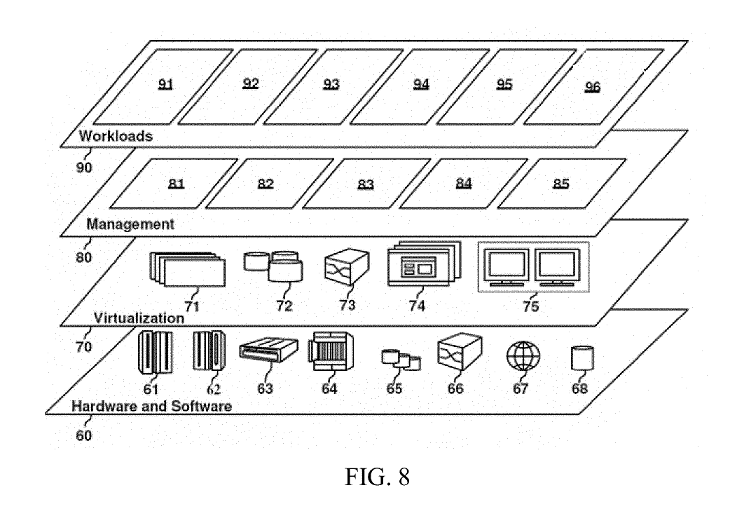

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and identifying relevant report objects for an ad-hoc analysis 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
identifying, by one or more processors, in at least one data dictionary associated with a reporting tool, report objects available in the generation of an ad-hoc report with the reporting tool;
contextualizing, by the one or more processors, at a given time, data accessible to the one or more processors, based on utilizing one or more communications connections;
determining, by the one or more processors, based on the at least one data dictionary associated with a reporting tool and the contextualized data, which report objects of the report objects available in the generation of an ad-hoc report are relevant to generating the ad-hoc report proximate to the given time; and
providing, by the one or more processors, the relevant report objects to the reporting tool.

2. The computer-implemented method of claim 1, wherein the providing comprises:
configuring, by the one or more processors, a reporting template in the reporting tool, wherein the reporting template includes the relevant report objects; and
utilizing, by the one or more processors, the reporting template to generate the ad-hoc report in the reporting tool.

3. The computer-implemented method of claim 1, wherein the providing comprises:
providing, by the one or more processors, through a graphical user interface of the reporting tool, concurrent with manual selection of a user of report objects in the reporting tool to generate the ad-hoc report, a recommendation, to the user, to select at least on report object of the relevant report objects in generating the ad-hoc report.

4. The computer-implemented method of claim 1, wherein the data accessible to the one or more processors comprises logs detailing interactions of at least one user with the reporting tool to generate the ad-hoc report, the method further comprising:
monitoring, by the one or more processors, user interaction with the reporting tool to generate the ad-hoc report.

5. The computer-implemented method of claim 1, further comprising:
determining, by the one or more processors, a role of a user interacting with the reporting tool to generate the ad-hoc report;
selecting, by the one or more processors, at least one additional report object from the available report objects, based on the role of the user; and
aggregating, by the one or more processors, the at least one additional report object with the recommended report objects.

6. The computer-implemented method of claim 1, wherein the relevant report objects are each selected from the group consisting of: a filter, a dimension, a measure, a key performance indicator, an attribute, and a drilling direction.

7. The computer-implemented method of claim 1, wherein the data accessible to the one or more processors comprises data from sources internal to a computer system executing the reporting tool.

8. The computer-implemented method of claim 7, wherein the data sources are selected from the group consisting of: emails, employee communications, organizational communications, minutes from meetings, employee feedback, and internal business reports.

9. The computer-implemented method of claim 1, wherein the data accessible to the one or more processors comprises data from sources external to a computer system executing the reporting tool.

10. The computer-implemented method of claim 9, wherein the data sources are selected from the group consisting of: media reports, social networking platforms, government policies, and published reports.

11. The computer-implemented method of claim 1, further comprising:
determining, by the one or more processors, a role of a user interacting with the reporting tool to generate the ad-hoc report;
identifying, by the one or more processors, at least one additional user in the role, wherein the at least one additional user generated the ad-hoc report proximate to the given time;
determining, by the one or more processors, specific report objects utilized by the at least one additional user; and
aggregating, by the one or more processors, the a specific report objects utilized by the at least one additional user with the recommended report objects.

12. A computer program product comprising:
a computer readable storage medium readable by one or more processors and storing instructions for execution by the one or more processors for performing a method comprising:
identifying, by the one or more processors, in at least one data dictionary associated with a reporting tool, report objects available in the generation of an ad-hoc report with the reporting tool;
contextualizing, by the one or more processors, at a given time, data accessible to the one or more processors, based on utilizing one or more communications connections;
determining, by the one or more processors, based on the at least one data dictionary associated with a reporting tool and the contextualized data, which report objects of the report objects available in the generation of an ad-hoc report are relevant to generating the ad-hoc report proximate to the given time; and
providing, by the one or more processors, the relevant report objects to the reporting tool.

13. The computer program product of claim 12, wherein the providing comprises:
configuring, by the one or more processors, a reporting template in the reporting tool, wherein the reporting template includes the relevant report objects; and
utilizing, by the one or more processors, the reporting template to generate the ad-hoc report in the reporting tool.

14. The computer program product of claim 12, wherein the providing comprises:
providing, by the one or more processors, through a graphical user interface of the reporting tool, concurrent with manual selection of a user of report objects in the reporting tool to generate the ad-hoc report, a recommendation, to the user, to select at least on report object of the relevant report objects in generating the ad-hoc report.

15. The computer program product of claim 12, wherein the data accessible to the one or more processors comprises logs detailing interactions of at least one user with the reporting tool to generate the ad-hoc report, the method further comprising:
monitoring, by the one or more processors, user interaction with the reporting tool to generate the ad-hoc report.

16. The computer program product of claim 12, further comprising:
determining, by the one or more processors, a role of a user interacting with the reporting tool to generate the ad-hoc report;
selecting, by the one or more processors, at least one additional report object from the available report objects, based on the role of the user; and
aggregating, by the one or more processors, the at least one additional report object with the recommended report objects.

17. The computer program product of claim 12, wherein the relevant report objects are each selected from the group consisting of: a filter, a dimension, a measure, a key performance indicator, an attribute, and a drilling direction.

18. The computer program product of claim 12, wherein the data accessible to the one or more processors comprises data from sources internal to a computer system executing the reporting tool.

19. The computer program product of claim 18, wherein the data sources are selected from the group consisting of: emails, employee communications, organizational communications, minutes from meetings, employee feedback, and internal business reports.

20. A system comprising:
a memory;
one or more processors in communication with the memory; and
program instructions executable by the one or more processors via the memory to perform a method, the method comprising:
identifying, by the one or more processors, in at least one data dictionary associated with a reporting tool, report objects available in the generation of an ad-hoc report with the reporting tool;
contextualizing, by the one or more processors, at a given time, data accessible to the one or more processors, based on utilizing one or more communications connections;
determining, by the one or more processors, based on the at least one data dictionary associated with a reporting tool and the contextualized data, which report objects of the report objects available in the generation of an ad-hoc report are relevant to generating the ad-hoc report proximate to the given time; and
providing, by the one or more processors, the relevant report objects to the reporting tool.
